(19) United States
(12) Patent Application Publication
(10) Pub. No.: US 2023/0133426 A1
(43) Pub. Date: May 4, 2023

(54) PROCESS AND APPARATUS FOR REACTING FEED WITH COOLED REGENERATED CATALYST

(71) Applicant: UOP LLC, Des Plaines, IL (US)

(72) Inventors: John J. Senetar, Naperville, IL (US); Avram M. Buchbinder, Chicago, IL (US); Wei Pan, Hoffman Estates, IL (US); Wolfgang A. Spieker, Glenview, IL (US); Richard A. Johnson, II, Algonquin, IL (US)

(21) Appl. No.: 17/884,424

(22) Filed: Aug. 9, 2022

Related U.S. Application Data
(60) Provisional application No. 63/274,936, filed on Nov. 2, 2021.

(51) Int. Cl. B01J 38/02; B01J 23/08; B01J 19/00

(52) U.S. Cl. CPC B01J 38/02; B01J 23/08; B01J 19/0053

(57) ABSTRACT

A fluidized catalytic reactor decouples the catalyst regenerator temperature from the catalyst reactor residence time. Regenerated catalyst is cooled before it contacts reactant feed. The regenerated catalyst may be cooled by heat exchange with oxygen supply gas, spent catalyst or other materials. The process and apparatus are especially useful for fluidized endothermic catalytic reactions.

### CROSS-REFERENCE TO RELATED APPLICATIONS

This application claims priority from U.S. Provisional Application No. 63/274,936, filed Nov. 2, 2021, which is incorporated herein in its entirety.

### FIELD

The field is the reaction of feed with fluid catalyst. The field may particularly relate to reacting a feed with a fluid catalyst to catalyze an endothermic reaction.

### BACKGROUND

Light olefin production is vital to the production of sufficient plastics to meet worldwide demand. Paraffin dehydrogenation (PDH) is a process in which light paraffins such as ethane and propane can be dehydrogenated to make ethylene and propylene, respectively. Dehydrogenation is an endothermic reaction which requires external heat to drive the reaction to completion. Fluid catalytic cracking (FCC) is another endothermic process which produces substantial ethylene and propylene.

Dehydrogenation catalyst may incorporate a dehydrogenation metal such as gallium with a molecular sieve or an amorphous material. The catalyst must be sufficiently robust and appropriately sized to be able to resist the attrition expected in a fluidized system. FCC catalyst is typically a Y zeolite with an optional MFI zeolite to boost propylene production.

In PDH and FCC reactions with fluidized catalyst, coke can deposit on the catalyst while catalyzing the reaction. The catalyst may be regenerated in a catalyst regenerator by combusting coke from the catalyst in the presence of oxygen. In some cases, addition fuel may be combusted in the regenerator to increase the temperature of the regenerated catalyst. The hot regenerated catalyst may then be transferred back to the reactor to catalyze the reaction. If insufficient heat is provided to drive the endothermic reaction, the conversion to desired products will be lower than desired. The extent of conversion therefore relies on the amount of heat introduced to the reaction.

For a given temperature in the regenerator, additional heat can be provided to the reaction through increased catalyst circulation. Alternatively, at a given catalyst circulation rate, additional heat can be provided by increasing the temperature of regenerated catalyst. Increased regeneration temperature may be favored to increase the activity of the regenerated catalyst and to lower the cost associated with regeneration by minimizing regenerator catalyst inventory and minimizing excess air requirements. The drawback of increased regeneration temperature is however that contacting feed with regenerated catalyst at higher temperature leads to additional thermal cracking reactions. Catalytic reactions are more selective to the desired products than thermal cracking reactions. Care must be taken to maximize catalytic reactions over thermal cracking reactions. Another drawback of higher regenerated catalyst temperature is that the lower circulation rate increases the residence time of catalyst in the reactor, as the catalyst inventory in the reactor is remains the same. Longer reactor residence time leads to increased catalyst deactivation.

There is a need, therefore, for improved methods to permit regeneration at higher temperature will minimizing undesirable cracking reactions and longer catalyst residence times in the reactor.

### BRIEF SUMMARY

A reactant stream is contacted with a cooled regenerated catalyst stream to produce a product gas stream. Spent catalyst is regenerated and cooled before it is passed into the regenerator. The cooled regenerated catalyst stream enters the regenerator at a lower temperature than a temperature of the hot regenerated catalyst stream. Cooling of catalyst enables the catalyst residence time in the reactor to be operated independently of the regenerator temperature.

### BRIEF DESCRIPTION OF THE DRAWINGS

FIG. 1 is a schematic drawing of a process and apparatus of the present disclosure;

FIG. 2 is a schematic drawing of a process and apparatus of an alternative embodiment of FIG. 1;

FIG. 3 is a schematic drawing of a process and apparatus of an additional alternative embodiment of FIG. 1;

FIG. 4 is a schematic drawing of a process and apparatus of a further alternative embodiment of FIG. 1; and

FIG. 5 is a plot of propane conversion in a dehydrogenation reaction vs. time on stream in the reactor for examples utilizing four different regeneration temperatures.

### DEFINITIONS

The term “communication” means that fluid flow is operatively permitted between enumerated components, which may be characterized as “fluid communication”.

The term “downstream communication” means that at least a portion of fluid flowing to the subject in downstream communication may operatively flow from the object with which it fluidly communicates.

The term “upstream communication” means that at least a portion of the fluid flowing from the subject in upstream communication may operatively flow to the object with which it fluidly communicates.

The term “direct communication” means that fluid flow from the upstream component enters the downstream component without passing through any other intervening vessel.

The term “indirect communication” means that fluid flow from the upstream component enters the downstream component after passing through an intervening vessel.

The term “bypass” means that the object is out of downstream communication with a bypassing subject at least to the extent of bypassing.

As used herein, the term “predominant” or “predominate” means greater than 50%, suitably greater than 75% and preferably greater than 90%.

### DETAILED DESCRIPTION

Catalyst residence time in a catalytic reactor can be an important parameter for determining catalyst deactivation. Catalyst residence time in a catalytic reactor is determined by Equation 1:

Tr_{cat}=W_{cat}/F_{cat} (1)

where Tr_{cat} is the catalyst residence time, W_{cat} is the mass of catalyst in the reactor and F_{cat} is the mass flow rate of circulated catalyst. Weight hourly space velocity (WHSV) in a reactor is determined by Equation 2:

WHSV=F_{f}/W_{cat} (2)

where F_{f} is the mass flow rate of feed to the reactor. Combining Equations 1 and 2 into Equation 3 provides the relationship between Tr_{cat} and WHSV:

$${Tr}_{cat} = \frac{{F}_{f}}{{F}_{cat} * WHSV} \qquad ( 3 )$$

Consequently, Tr_{cat} is dependent on F_{cat} and WHSV required for the reaction.

The heat supplied to the reactor is given by Equation 4:

Qᵣₓₙ=F_{cat}*Cₚ*(T_{regen}−Tᵣₓₜᵣ) (4)

where Qᵣₓₙ is the heat supplied to the reactor, Cₚ is the specific heat constant of the catalyst, T_{regen} is the temperature of the regenerator and Tᵣₓₜᵣ is the temperature of the reactor. Rearranging Equation 4 yields Equation 5:

$${F}_{cat} = \frac{{Q}_{rxn}}{Cp * ( {T}_{regen} - {T}_{rxtr} )} \qquad ( 5 )$$

Combining Equations 3 and 5 provides Equation 6:

$${Tr}_{cat} = \frac{{F}_{f} * Cp * ( {T}_{regen} - {T}_{rxtr} )}{{Q}_{rxn} * WHSV} \qquad ( 6 )$$

Consequently, catalyst residence time, Tr_{cat}, depends on the heat requirements of the reaction, Qᵣₓₙ, and the temperature difference between the reactor and the regenerator, T_{regen}−Tᵣₓₜᵣ. Thus, one cannot select a catalyst residence time in the reactor independently of the regenerator temperature.

Catalyst deactivation in the reactor is dependent on catalyst residence time in the reactor. Catalyst activity falls over time in the reactor as the catalyst accumulates coke and/or the catalyst is deactivated by the deactivating atmosphere in the reactor. For example, for propane dehydrogenation, the catalyst is deactivated both by coke blocking active sites and by exposure to reducing conditions in the reactor. In FCC, catalyst is deactivated by coke blocking active sites. The objective is to select an acceptable catalyst residence time in the reactor independent of other constraints.

Catalyst regeneration is governed by the regeneration conditions. The regeneration temperature, T_{regen}, is a key variable. One would generally seek a regeneration temperature as high as practical to favor complete regeneration of the catalyst and, if needed, to promote the rapid burning of the optional fuel gas supplemented to the regenerator to increase enthalpy. As the regeneration temperature is increased, the required catalyst circulation rate to supply heat to the reactor decreases. The effect is increased residence time in the reactor and resulting lower catalyst activity due to catalyst deactivation in the reactor over time-on-stream. We have found the key to independently selecting an acceptable catalyst residence time in the reactor is the capability to decouple the catalyst circulation rate from the temperature in the regenerator, Tᵣₓₜᵣ.

We have discovered a way to decouple the catalyst residence time in the reactor from the regeneration temperature. The process and apparatus can operate both with a short reactor catalyst residence time and with high temperature in the regenerator at a fixed space velocity and constant conversion. The process and apparatus achieve the desired effect by cooling the regenerated catalyst before it is fed to the reactor. In order to be practical, the heat recovered from cooling of the regenerated catalyst should be recovered for use in the process. Most favorably, the heat should be recovered so as to have a minimal impact on the fuel requirement for the regenerator.

The teachings herein may be applicable to any process that requires catalyst to be regenerated to provide heat to drive an endothermic catalytic reaction. Cooling of catalyst for an exothermic reactor is well known; however, the invention here demonstrates the surprising benefit of cooling catalyst for a reactor that houses an endothermic reaction. Paraffin dehydrogenation (PDH) and fluid catalytic cracking (FCC) are examples of endothermic processes. FCC catalyst is used to crack larger hydrocarbon molecules to smaller hydrocarbon molecules at around atmospheric pressure and about 427° C. (800° F.) to 538° C. (1000° F.) and a catalyst to oil ratio of about 5 to about 30. PDH catalyst is used in a dehydrogenation reaction process to catalyze the dehydrogenation of paraffins, such as ethane, propane, iso-butane, and n-butane, to olefins, such as ethylene, propylene, isobutene and n-butenes, respectively. The PDH process will be described exemplarily to illustrate the disclosed apparatus and process.

The conditions in the dehydrogenation reactor may include a temperature of about 500 to about 800° C., a pressure of about 40 to about 310 kPa and a catalyst to oil ratio of about 5 to about 100. The dehydrogenation reaction may be conducted in a fluidized manner such that gas, which may comprise the reactant paraffins with or without a fluidizing inert gas, is distributed to the reactor in a way that lifts the dehydrogenation catalyst in the reactor vessel while catalyzing the dehydrogenation of paraffins. During the catalytic dehydrogenation reaction, coke is deposited on the dehydrogenation catalyst leading to reduction of the activity of the catalyst. The dehydrogenation catalyst must then be regenerated.

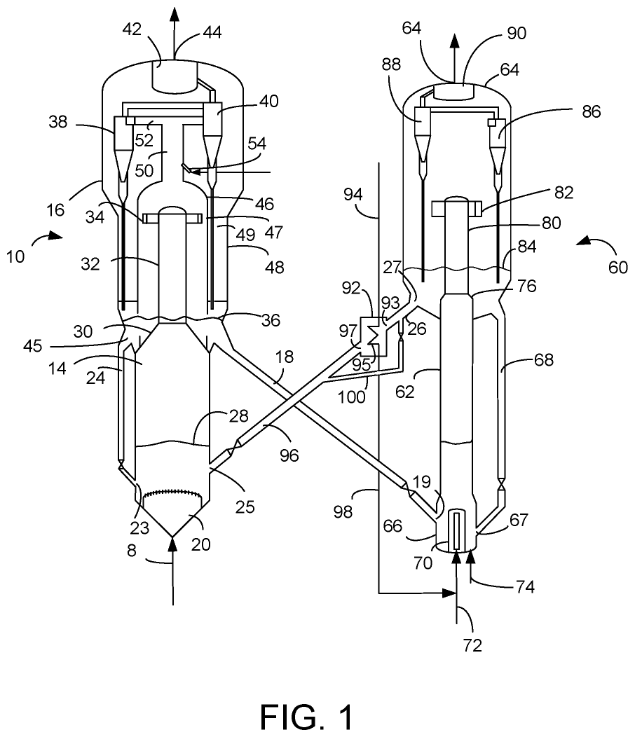

An exemplary PDH reactor 10 is shown in FIG. 1. The PDH reactor 10 may comprise two chambers, a reaction chamber 14 and a separation chamber 16. A feed line 8 may charge a reactant stream of feed to the reactor 10. The reactant stream may predominantly comprise propane or butane, but other paraffins such as ethane may be present in the reactant stream in conjunction with or to the exclusion of other paraffins. Any feed distributor can distribute the reactant stream to the reactor 10. A domed reactant distributor 20 may be utilized in the reaction chamber 14 of the reactor 10. The domed reactant distributor 20 receives a gaseous reactant stream and distributes the reactant stream through nozzles in the top dome of the domed reactant distributor 20 to distribute the reactant stream across the entire cross section of the reaction chamber 14. It is envisioned that other fluidizing gases may be used to also promote fluidization in the reaction chamber 14. In an embodiment, the distributed reactant stream ascends in the reaction chamber 14 and the reactor 10.

A recycle catalyst pipe 22 has an inlet end 21 located in the separation chamber 16 and an outlet comprising a first catalyst inlet 23 which in an embodiment may be connected to the reaction chamber 14. The recycle catalyst pipe 22 passes a first stream of recycled spent catalyst that has not undergone regeneration from the separation chamber 16 through the outlet and the first catalyst inlet 23 to the reaction chamber 14 in an embodiment. The first catalyst inlet 23 provides spent catalyst to the reaction chamber 14. The recycled spent catalyst is fed to the reactor 10 through the first catalyst inlet 23 which is the outlet of the recycle catalyst pipe 22. The first catalyst inlet 23 may be contained in the first reaction chamber 14.

A second catalyst inlet 25 delivers a second catalyst stream to the reactor 10. A regenerated catalyst pipe 26 has an inlet 27 in upstream communication with the second catalyst inlet 25. An inlet end of the regenerated catalyst pipe 26 is connected to the regenerator 60. The regenerated catalyst pipe 26 passes a second stream of regenerated catalyst from a regenerator 60 to the second catalyst inlet 25. The regenerated catalyst pipe may be in downstream communication with the regenerator 60. The second catalyst inlet 25 is contained in and provides regenerated catalyst to the reaction chamber 14. The reactant stream is contacted with the second catalyst stream and the first catalyst stream in the reaction chamber 14. The second catalyst inlet 25 may be spaced apart and may be above the first catalyst inlet 23.

In the reaction chamber 14 the reactant stream is contacted with the second stream of catalyst and the first stream of catalyst which mix together, and the reactant paraffins undergo endothermic conversion to olefins, typically propane to propylene. The reactant stream and the first stream of catalyst and the second stream of catalyst rise in the reaction chamber 14 of the reactor 10 impelled by the reactant stream continually entering the reactor.

At an interface 28, the fluid dynamics transition from a dense phase of catalyst below the transition to a fast-fluidized flow regime. The catalyst density in the dense phase of catalyst is at least 200 kg/m³ (12.5 lb/ft³); whereas the catalyst density in the fast-fluidized flow regime is at least 100 kg/m³ (6.3 lb/ft³). The superficial velocity of the reactant stream and the first stream of catalyst and the second stream of catalyst in the reaction chamber 14 will typically be at least about 0.9 m/s (3 ft/s), suitably at least about 1.1 m/s (3.5 ft/s), preferably at least 1.4 m/s (4.5 ft/s), to about 2.1 m/s (7 ft/s) to provide the fast-fluidized flow regime. Reactant gas and catalyst ascend in a fast-fluidized flow regime in which catalyst may slip relative to the gas and the gas can take indirect upward trajectories.

The dehydrogenation catalyst selected should minimize cracking reactions and favor dehydrogenation reactions. Suitable catalysts for use herein include an active metal which may be dispersed in a porous inorganic carrier material such as silica, alumina, silica alumina, zirconia, or clay. An exemplary embodiment of a catalyst includes alumina or silica-alumina containing gallium, a noble metal, and an alkali or alkaline earth metal.

The catalyst support comprises a carrier material, a binder and an optional filler material to provide physical strength and integrity. The carrier material may include alumina or silica-alumina. Silica sol or alumina sol may be used as the binder. The alumina or silica-alumina generally contains alumina of gamma, theta and/or delta phases. The catalyst support particles may have a nominal diameter of about 20 to about 200 micrometers with the average diameter of about 50 to about 150 micrometers. Preferably, the surface area of the catalyst support is 85-140 m²/g.

The dehydrogenation catalyst may comprise a dehydrogenation metal on a support. The dehydrogenation metal may be a one or a combination of transition metals. A noble metal may be a preferred dehydrogenation metal such as platinum or palladium. Gallium is an effective metal for paraffin dehydrogenation. Metals may be deposited on the catalyst support by impregnation or other suitable methods or included in the carrier material or binder during catalyst preparation.

The acid function of the catalyst should be minimized to prevent cracking and favor dehydrogenation. Alkali metals and alkaline earth metals may also be included in the catalyst to attenuate the acidity of the catalyst. Rare earth metals may be included in the catalyst to control the activity of the catalyst. Concentrations of 0.001% to 10 wt % metals may be incorporated into the catalyst. In the case of the noble metals, it is preferred to use about 10 parts per million (ppm) by weight to about 600 ppm by weight noble metal. More preferably it is preferred to use 10-100 ppm by weight noble metal. The preferred noble metal is platinum. Gallium should be present in the range of 0.3 wt % to about 3 wt %, preferably about 0.5 wt % to about 2 wt %. Alkali and alkaline earth metals are present in the range of about 0.05 wt % to about 1 wt %.

The reactant stream lifts the first stream of catalyst mixed with the second stream of catalyst upwardly in the reaction chamber while paraffins convert to olefins in the presence of the dehydrogenation catalyst which gradually becomes spent catalyst attributed to the agglomeration of coke deposits on the catalyst. A fluidizing inert gas may be distributed to the reaction chamber to assist in lifting the mixture of catalyst and reactants upwardly in the reaction chamber 14. The reactant gases convert to product gases while ascending in the reaction chamber 14. The blend of gases and catalyst ascend from the reaction chamber 14 through a frustoconical transition section 30 into a transport riser 32 which has a smaller diameter than the diameter of the reaction chamber 14. A blend of gases and catalyst accelerate in the narrower transport riser 32 and are discharged from a primary catalyst separator 34 into the separation chamber 16. The primary catalyst separator 34 may be a riser termination device that utilizes horizontal, centripetal acceleration to separate spent catalyst from product gas. Arcuate ducts of the primary catalyst separator 34 direct the mixture of product gas and catalyst to exit from the riser 32 in a typically horizontally angular direction to centripetally accelerate causing the denser catalyst to gravitate outwardly. The catalyst loses angular momentum and falls into a lower catalyst bed 36 depicted with an upper interphase. The lighter gases ascend in the separation chamber 16 and enter into cyclones 38, 40. The cyclones 38, 40 may comprise first and second cyclonic stages of separation to further remove catalyst from product gases. The product gas is ducted to a plenum 42 from which it is discharged from the reactor 10 through a product outlet 44 in a product line. The superficial gas velocity in the transport riser 32 will be about 12 m/s (40 ft/s) to about 20 m/s (70 ft/s) and have a density of about 64 kg/m³ (4 lb/ft³) to about 160 kg/m³ (10 lb/ft³), constituting a dilute catalyst phase.

Catalyst separated from the product gas by the primary catalyst separator 34 drops into the dense catalyst bed 36. In an aspect, primary cyclones 38 may collect product gas from the separation chamber 16 and transport the product gas separated from catalyst to a secondary cyclone 40 to further separate catalyst from the product gas before directing secondarily purified product gas to the plenum 42. Catalyst separated from product gas in the cyclones 38, 40 is dispensed by dip legs into the dense catalyst bed 36. At this point, the separated catalyst in the separation chamber 16 is considered spent catalyst because deposits of coke are agglomerated thereon. A spent catalyst stream taken from the spent catalyst collected in the dense bed 36 in the separation chamber 16 is transported in a spent catalyst pipe 18 to a catalyst regenerator 60 to have coke burned from the catalyst to regenerate and heat the dehydrogenation catalyst.

A recycle catalyst stream is taken from the spent catalyst collected in the dense bed 36 of the separation chamber 16 and enters the recycle catalyst pipe 22 through an inlet 21. The recycle catalyst stream of the spent catalyst is recycled in the recycle catalyst pipe 22 back to the first catalyst inlet 23 in the reaction chamber 14 of the reactor 10. The recycle catalyst stream of the spent catalyst is not regenerated before it returns to the reaction chamber 14.

The separation chamber 16 may include a disengagement can 46 that surrounds the upper end of the riser 32 and the primary separator 34. A vertical wall 47 of the disengagement can 46 is spaced apart from a shell 48 of the separation chamber to define an annulus 49. Dip legs of the cyclones 38 and 40 may be located in the annulus 49. The disengagement can 46 serves to limit travel of the product gas exiting the primary separator 34, so as to reduce its time in the reactor 10, thereby mitigating unselective cracking reactions to undesired products. The top of the disengagement can 46 may be hemispherical and feed a gas recovery conduit 50 that transports product gases to ducts 52 that are directly ducted or connected to the primary cyclones 38. The direct ducting from the disengagement can 46 to the primary cyclones 38 also prevents product gas from getting loose in the larger volume of the reactor vessel where excessive residence time may occur to permit unselective cracking. Windows in the lower section of the wall 48 of the disengagement can 46 permit catalyst in the disengagement to enter into the recycle catalyst pipe 22 or the regeneration pipe 18. A quench fluid such as condensed product liquid, cooled recycled gas, or even cool catalyst may be injected into the product gases through a quench nozzle 54 to cool the product gases to below cracking temperature to limit unselective cracking. Quench fluid is advantageously injected into the gas recovery conduit 50 which directs the separated product gas to a narrowed location. The gas recovery conduit 50 is in downstream communication with primary catalyst separator 34 which separates the predominance of the spent catalyst from the product gases. The primarily separated spent catalyst bypasses quenching to retain heat in the catalyst. The product gases separated from the predominance of the catalyst subjects a reduced mass of material to quenching thereby requiring less quench fluid to achieve sufficient cooling to reduce the temperature of product gas to below cracking temperature.

The spent catalyst is transported to the catalyst regenerator vessel 60 to regenerate the spent catalyst into regenerated catalyst and to combust the coke if present. The catalyst regenerator vessel 60 includes a combustion chamber 62, which may be a lower chamber, and a separation chamber 64, which may be an upper chamber. The combustion chamber 62 may include a mixing chamber 66 which mixes streams of catalyst and distributes gases to the catalyst. In the separation chamber 64, the regenerated catalyst is separated from flue gas generated in the combustion chamber 62.

In an exemplary embodiment, the regenerator vessel 60 includes a mixing chamber 66. The mixing chamber 66 may be located at a lower end of the of the combustion chamber 62 and the regenerator vessel 60. The mixing chamber 66 may be connected to an outlet end 19 of a spent catalyst pipe 18 which serves as an inlet for the mixing chamber. The spent catalyst standpipe 18 transports spent catalyst from the dehydrogenation reactor 10 to the catalyst regenerator vessel 60 through a control valve. In some cases, the spent catalyst standpipe 18 may transport catalyst to the regenerator vessel 60 via a spent catalyst stripper (not shown). The mixing chamber 66 may also include a regenerated catalyst pipe inlet 67 from a regenerated catalyst standpipe 68 which serves as an outlet for the regenerated catalyst pipe. Heated regenerated catalyst from the separation chamber 64 may be transported back to the catalyst regenerator vessel 60 through a recycle regenerated catalyst pipe 68 through a control valve to further heat catalyst in the regenerator vessel 60 by contact with hot regenerated catalyst.

The outlet end 19 of the spent catalyst pipe discharges a stream of spent catalyst from a spent catalyst standpipe 18 into the mixing chamber 66, and the regenerated catalyst pipe inlet 67 discharges the recycled portion of regenerated catalyst from the regenerated catalyst pipe 68 into the mixing chamber 66. The mixing chamber 66 receives a stream of spent catalyst and a stream of hot regenerated catalyst and mixes them together to provide a mixture of catalyst. While mixing, the hotter regenerated catalyst heats the cooler spent catalyst which serves to provide a heated catalyst mixture.

A mixing baffle 70 may be positioned within the mixing chamber 66 in an embodiment, to facilitate mixing between the spent catalyst and the regenerated catalyst. The mixing baffle 70 may comprise a capped cylinder with openings opposed to catalyst inlets 19 or 67.

An oxygen supply gas line 72 provides oxygen supply gas into the mixing chamber 66. The oxygen supply gas from the oxygen supply gas line 72 includes oxygen necessary for combustion. The oxygen supply gas may also fluidize the catalyst within the mixing chamber 66 and lift the catalyst from the mixing chamber upwardly into the combustion chamber 62.

Coke on the spent catalyst may be insufficient to generate enough enthalpy from combustion to drive the endothermic reaction in the dehydrogenation reactor. In some cases, the catalyst may deactivate by a mechanism other than coke deposition and require oxidation to regenerate activity, even though very little or no detectable coke is on the spent catalyst. Moreover, higher regeneration temperature results in greater restoration of catalyst activity. Hence, supplemental fuel gas may be added to the mixing chamber 66 in the regenerator vessel 60 to provide additional combustion enthalpy to drive the endothermic reaction in the dehydrogenation reactor and sufficiently restore catalyst activity. A fuel gas from a fuel gas line 74 may be provided to the combustion chamber 62 perhaps through the mixing chamber 66. Both gas streams lift the catalyst in the combustion chamber 62 into the separation chamber 64.

The fuel gas is combusted with oxygen in the oxygen supply gas in the presence of the catalyst to provide a heated, regenerated catalyst. Moreover, coke on catalyst is also combusted from the catalyst with oxygen in the oxygen supply gas to provide a regenerated catalyst. Combustion of coke and fuel gas generates flue gas. In an embodiment, the fuel gas and the coke on the catalyst are combusted together in the same vicinity, beginning in the mixing chamber 66 and then in the combustion chamber 62.

The superficial gas velocity in the mixing chamber 66 may be about 0.9 m/s (3 ft/s), to about 5.4 m/s (18 ft/s), and the catalyst density may be from about 112 kg/m³ (7 lb/ft³) to about 400 kg/m³ (25 lb/ft³), preferably from about 48 kg/m³ (3 lb/ft³) to about 288 kg/m³ (18 lb/ft³), constituting a dense catalyst phase in the mixing chamber 66.

In an exemplary embodiment, air is used as the oxygen supply gas, because air is readily available and provides sufficient oxygen for combustion. About 10 to about 15 kg of air are required per kg of coke burned off of the spent catalyst. Exemplary regeneration conditions in the combustion chamber 62 include a temperature from about 690° C. to about 800° C., preferably 705° C. to about 750° C. and a pressure of about 6.9 kPa (gauge) (1 psig) to about 450 kPa (gauge) (70 psig).

Catalyst, fuel gas and oxygen supply gas ascend in the combustion chamber 62 while coke is combusted from the catalyst and the fuel gas is combusted to regenerate and heat the catalyst and generate flue gas. The flow regime may be a fast-fluidized flow regime in which catalyst may slip relative to the gas and the gas can take indirect upward trajectories. The superficial velocity of the gases ascending in the combustion chamber 62 is preferably about 1.5 m/s (5 ft/s) to about 6 m/s (20 ft/s) and preferably about 2.1 m/s (7 ft/s) to about 5.4 m/s (18 ft/s), to provide a fast-fluidized flow regime. The catalyst density in a dilute catalyst phase in the combustion chamber 62 will be from about 16 kg/m³ (1 lb/ft³) to about 192 kg/m³ (12 lb/ft³).

The blend of gases and catalyst ascend from the combustion chamber 62 through a frustoconical transition section 76 into a riser 80 which has a smaller diameter than a major diameter of the combustion chamber 62. A blend of gases and catalyst accelerate in the narrower riser 80 and are discharged from a riser termination device 82 into the separation chamber 64. The transition section 76, the riser 80 and the riser termination device 82 are considered part of the combustion chamber 62. The riser termination device 82 may utilize centripetal acceleration to separate regenerated catalyst from flue gas. The superficial gas velocity in the riser 80 will be about 6 m/s (20 ft/s) to about 15 m/s (50 ft/s) and constitute a dilute catalyst phase.

Regenerated catalyst separated from flue gas by the riser termination device 82 drops into a dense catalyst bed 84. The catalyst separation chamber 64 may include one or more regenerator cyclones 86 or other solid/gaseous separator devices to separate the regenerated catalyst still entrained in the flue gas. In an aspect, primary cyclones 86 may collect flue gas from the separation chamber 64 and transport the flue gas separated from catalyst to a secondary cyclone 88 to further separate regenerated catalyst from the flue gas before directing secondarily purified flue gas to the plenum 90. Flue gas is discharged from the regenerator vessel 60 through an outlet 62 in a discharge line. Regenerated catalyst separated from flue gas in the cyclones 86, 88 is dispensed by dip legs into the dense catalyst bed 84.

A stream of fluidizing gas may be distributed into the separation chamber 64 to fluidize regenerated catalyst in the dense catalyst bed 84. The fluidizing gas may be an oxygen supply gas such as air used in the combustion chamber 62 or it may be inert such as steam or nitrogen.

A return portion of the regenerated catalyst collected in the dense bed 84 of the catalyst separation chamber 64 may be transported in the return regenerated catalyst standpipe 26 back to the dehydrogenation reactor ready for catalyzing dehydrogenation reactions. The return portion of the regenerated catalyst may exit the separation chamber 64 through an inlet end 27 of the regenerated catalyst pipe 26 to enter the return regenerated catalyst standpipe 26.

A recycle portion of the regenerated catalyst collected in the dense bed 84 of the catalyst separation chamber 64 may be recycled in a recycle regenerated catalyst standpipe 68 back to the combustion chamber 62 of the regenerator vessel 60 via the mixing chamber 66. The regenerated catalyst is hotter and has a lower coke concentration than the spent catalyst fed to the regenerator vessel in the spent catalyst standpipe 18. Regenerated catalyst is returned to the reactor 10 at least in part in the regenerated catalyst pipe 26.

The regenerated catalyst pipe 26 has an inlet end 27 connected to the regenerator 20 in the separation chamber 25 through which regenerated catalyst from the regenerator is transported to the reactor 10. To decouple the regenerated catalyst temperature from the catalyst residence time in the reactor 10, the regenerated catalyst in the regenerated catalyst pipe 26 may be cooled in a catalyst cooler 92. The hot regenerated catalyst is fed to the catalyst cooler 92 from the regenerated catalyst pipe 26 through an outlet end 93 of the regenerated catalyst pipe. The outlet end 93 may be connected to the catalyst cooler 92. The catalyst cooler 92 may be in downstream communication with the regenerated catalyst pipe 26. A stream of gas such as an oxygen supply gas in line 94 may be fed to the catalyst cooler 92 through a coil 95 in the catalyst cooler 92 to be indirectly heat exchanged with the hot regenerated catalyst. Cooled regenerated catalyst exits the catalyst cooler 92 through an inlet end 97 of a cooled catalyst pipe 96. The inlet end of the cooled catalyst pipe 96 may be connected to the catalyst cooler 92. The cooled catalyst pipe may be in downstream communication with the catalyst cooler 92. The cooled regenerated catalyst pipe delivers the cooled regenerated catalyst stream to the reactor 10 through an outlet end 25 at a flow rate governed by a control valve thereon. The outlet end 25 may be connected to the reactor 10. The reactor 10 may be in downstream communication with the cooled catalyst pipe 96. The cooled regenerated catalyst stream is fed to the reactor 10 through inlet 25 at a lower temperature than a temperature of the hot regenerated catalyst stream that exits the regenerator 60 through the inlet end 27. The oxygen supply gas in line 94 is heated by heat exchange with the hot regenerated catalyst from pipe 26 and exits the catalyst cooler 92 in line 98. The heated oxygen supply gas may be fed to the regenerator 60 to provide oxygen supply gas requirements perhaps merging in with the oxygen supply gas in the oxygen supply gas line 72. Heating the oxygen supply gas before entering the regenerator facilitates combustion of coke deposits on catalyst and fuel gas combustion. The oxygen supply gas in line 94 can be heated by about 450 to about 660° C., and the hot regenerated catalyst stream can be cooled by about 20 to about 50° C. Heating the oxygen supply gas may be used in conjunction with heating other streams such as fuel gas or steam to provide sufficient catalyst cooling.

In an embodiment, the regenerated catalyst pipe 26 may be equipped with a bypass line 100 with a control valve thereon for regulating the flow rate of catalyst to the catalyst cooler 92 independently of the flow rate of oxygen supply gas to the catalyst cooler in line 94.

The catalyst cooler 92 may also be used to generate steam, superheat steam or provide heat to another area of the process while cooling catalyst to be fed to the reactor 10 in the cooled catalyst conduit 96 to enable a higher catalyst circulation rate independent of catalyst regeneration conditions.

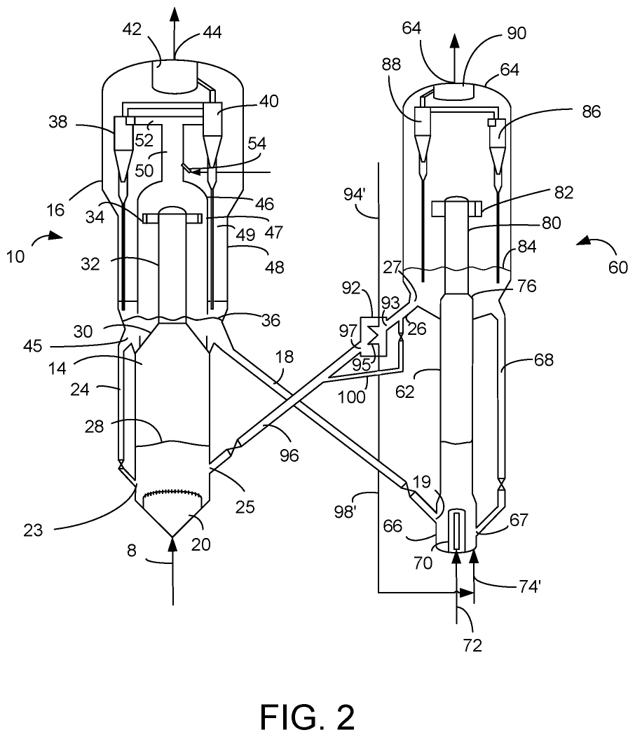

FIG. 2 shows an embodiment of an alternative regenerator 60′ which employs fuel gas to cool hot regenerated catalyst. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The configuration and operation of the embodiment of FIG. 2 is essentially the same as in FIG. 1 with the following exceptions.

The hot regenerated catalyst is fed to the catalyst cooler 92 from the regenerated catalyst pipe 26 through an outlet end 93 of the regenerated catalyst pipe. A stream of fuel gas comprising light hydrocarbons and/or hydrogen in line 94′ may be fed to the catalyst cooler 92 through a coil 95 in the catalyst cooler 92 to be indirectly heat exchanged with the hot regenerated catalyst. Cooled regenerated catalyst exits the catalyst cooler 92 through an outlet 97 into a second regenerated catalyst pipe 96. The second regenerated catalyst pipe delivers the cooled regenerated catalyst stream to the reactor 10 through an inlet 25 at a flow rate governed by a control valve thereon. The cooled regenerated catalyst stream is fed to the reactor 10 through inlet 25 at a lower temperature than a temperature of the hot regenerated catalyst stream that exits the regenerator 60 through the inlet end 27 of the regenerated catalyst pipe 26. The fuel gas in line 94′ is heated by heat exchange with the hot regenerated catalyst from pipe 26 and exits the catalyst cooler 92 in line 98′. The heated fuel gas may be fed to the regenerator 60 to provide fuel gas requirements perhaps merging in with the fuel gas in the fuel gas line 74′. Heating the fuel gas before entering the regenerator facilitates combustion of fuel gas because the fuel gas does not require full heating in the regenerator. The fuel gas in line 94 can be heated by about 500 to about 700° C., and the hot regenerated catalyst stream can be cooled by about 2 to about 10° C. Heating the fuel gas may be used in conjunction with heating other streams such as fuel gas or steam to provide sufficient catalyst cooling.

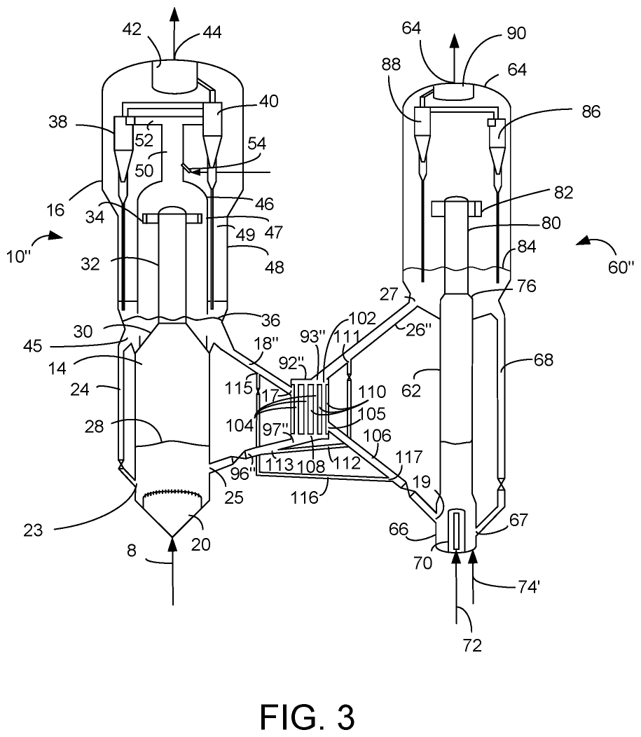

FIG. 3 shows an embodiment of an alternative reactor 10″ and regenerator 60″ which cools hot regenerated catalyst by heat exchanging it with spent catalyst. Elements in FIG. 3 with the same configuration as in FIG. 1 will have the same reference numeral as in FIG. 1. Elements in FIG. 3 which have a different configuration as the corresponding element in FIG. 1 will have the same reference numeral but designated with a double prime symbol (″). The configuration and operation of the embodiment of FIG. 3 is essentially the same as in FIG. 1 with the following exceptions.

A catalyst cooler 92″ comprises a catalyst heat exchanger in downstream communication with the regenerated catalyst pipe 26″ and the spent catalyst pipe 18″. The catalyst cooler 92″ has a first side in communication with the regenerated catalyst pipe 26″ and the cooled catalyst pipe 96″. An outlet end 93″ of the regenerated catalyst pipe 26″ is connected to a manifold 102 of the catalyst cooler 92″. The manifold 102 receives hot regenerated catalyst from the regenerated catalyst pipe 26″ and distributes the hot regenerated catalyst to a plurality of catalyst tubes 104 or channels comprising a first side of the catalyst cooler 92″. A collector 108 receives catalyst from the tubes 104. An inlet end 97″ of the cooled catalyst pipe 96″ is connected to the catalyst cooler 92″ on the first side to receive cooled catalyst from the collector 108.

A second side of said catalyst cooler 92″ may be in communication with the spent catalyst pipe 18″ and a heated catalyst pipe 106. Spaces 110 between the tubes 104 receive the spent catalyst from the spent catalyst pipe 18″. The catalyst cooler 92″ is in downstream communication with the spent catalyst pipe 18″. Specifically, an outlet end 17 of the spent catalyst pipe 18″ is connected to the catalyst cooler 92″ on the second side, and an inlet end 105 of the heated catalyst pipe 106 is connected to the catalyst cooler 92″ on the second side.

Hot regenerated catalyst from the regenerated catalyst pipe 26″ exits an outlet end 93″ and enters the manifold 102 and is distributed to the catalyst tubes 104 on the first side of the catalyst cooler 92″. Spent catalyst from the spent catalyst pipe 18″ exits the outlet end 17 and enters the spaces 110 between tubes 104 on the second side of the catalyst cooler 92″. Heat is indirectly exchanged across the tubes 104 from the regenerated catalyst to the spent catalyst thereby heating the spent catalyst and cooling the regenerated catalyst. The heated spent catalyst exits the spaces 110 between the tubes 104 through the inlet end 105 of the heated catalyst pipe 106, and cooled regenerated catalyst collects in the collector 108 and exits the catalyst cooler 92″ through an inlet end 97″ of a cooled catalyst pipe 96″. The cooled catalyst from the cooled catalyst pipe 96″ is passed to the reactor 10 through the outlet end 25, and the heated spent catalyst stream is passed to the regenerator 60 through the outlet end 19 of the heated catalyst pipe 106. The catalyst cooler 92″ may be in downstream communication with the spent catalyst pipe 18″, and the regenerator 60 may be in downstream communication with the heated catalyst pipe 106. The spent catalyst stream in the spent catalyst pipe 18″ can be heated by about 20 to about 60° C., and the hot regenerated catalyst stream in the regenerated catalyst pipe 26″ can be cooled by about 20 to about 60° C.

Adjusting the flow rate of hot regenerated catalyst in pipe 26″ to the catalyst cooler 92″ can be used to control the rate of cooling of hot regenerated catalyst. To do so, a regenerated catalyst bypass pipe 112 has an inlet end 111 connected to the regenerated catalyst pipe 26″ and an outlet end 113 connected to the cooled catalyst pipe 96″. Modulating the rate of hot regenerated catalyst by bypassing a portion of the hot regenerated catalyst in the regenerated catalyst pipe 26″ around the catalyst cooler 92″ in the bypass pipe 112 by a control valve thereon can control the temperature of the regenerated catalyst entering the reactor 10″ through the outlet end 25 of the cooled catalyst pipe 96″. Bypassing more of the hot regenerated catalyst in the regenerated catalyst pipe 26″ through the regenerator bypass pipe 112 to mix with cooled catalyst in the cooled catalyst line 96″ will increase the temperature of the cooled regenerated catalyst in the cooled catalyst line. Bypassing less of the hot regenerated catalyst in the regenerated catalyst pipe 26″ through the regenerator bypass pipe 112 to mix with cooled catalyst in the cooled catalyst line 96″ will decrease the temperature of the cooled regenerated catalyst in the cooled catalyst line.

Adjusting the flow rate of spent catalyst in pipe 18″ to the catalyst cooler 92″ can also be used to control the rate of cooling of hot regenerated catalyst. To do so, a spent catalyst bypass pipe 116 having an inlet end 115 connected to the regenerated catalyst pipe 26″ and an outlet end 117 connected to the heated catalyst pipe 106. Modulating the rate of spent catalyst by bypassing a portion of the spent catalyst in the spent catalyst pipe 18″ around the catalyst cooler 92″ in the bypass pipe 116 can control the temperature of the regenerated catalyst entering the reactor 10″ through the outlet end 25 of the cooled catalyst pipe 96″. Bypassing more of the spent catalyst in the spent catalyst pipe 18″ through the spent bypass pipe 116 will provide less cooling of the hot regenerated catalyst in the hot regenerated catalyst pipe 26″ to increase the temperature of the cooled regenerated catalyst in the cooled catalyst pipe 96″. Bypassing less of the spent catalyst in the spent catalyst pipe 18″ through the spent bypass pipe 116 will provide more cooling in the cooled catalyst line 96″ to decrease the temperature of the cooled regenerated catalyst in the cooled catalyst line.

A fluidizing gas line 130 may feed a distributor on the first side of the catalyst heat exchanger 92″ and/or on the second side of the catalyst heat exchanger. One can adjust the degree of heat transfer by varying the degree of fluidization of catalyst on either side or both sides of the catalyst heat exchanger 92″. Increasing the degree of fluidization will increase heat transfer between catalyst streams, and reducing the degree of fluidization will decrease heat transfer between catalyst streams.

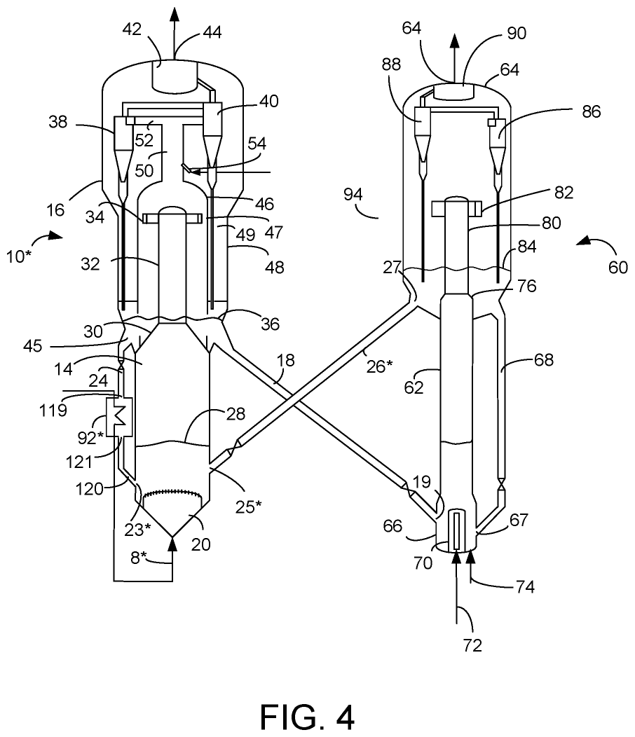

FIG. 4 shows an embodiment of an alternative reactor 10* which cools hot regenerated catalyst by mixing it with cooled spent catalyst. Elements in FIG. 4 with the same configuration as in FIG. 1 will have the same reference numeral as in FIG. 1. Elements in FIG. 4 which have a different configuration as the corresponding element in FIG. 1 will have the same reference numeral but designated with a star symbol (*). The configuration and operation of the embodiment of FIG. 4 is essentially the same as in FIG. 1 with the following exceptions.

The recycle catalyst stream of spent catalyst taken in the recycle catalyst pipe 22* from the inlet end 21 may be cooled in a catalyst cooler 92* from which it enters through an outlet end 119 of the recycle catalyst pipe. The catalyst cooler 92* may cool the recycle catalyst stream by heat exchange with a stream of oxygen supply gas or fuel gas intended for the regenerator, regenerated catalyst, water or paraffin feed intended for the reactor 10*. In FIG. 4 a reactant stream of paraffin feed in line 6 is preheated by heat exchange with the recycle catalyst stream of spent catalyst in the recycle catalyst pipe 22*. In the heat exchange, the catalyst cooler 92* cools the recycle catalyst stream by heat exchange with the cooler reactant stream in line 6 to produce a preheated reactant stream in the feed line 8*. The cooled recycle catalyst stream may exit the catalyst cooler 92* through an inlet end 121 of a cooled catalyst pipe 120 and be fed to the reactor 10* through an outlet end 23* of the cooled catalyst pipe.

The hot regenerated catalyst stream entering the reactor 10* through inlet end 25* from the regenerated catalyst pipe 26* is cooled when it mixes with a cooled recycle catalyst stream entering through the outlet end 23* of the cooled catalyst pipe 120 to provide the cooled regenerated catalyst stream in the catalyst bed represented by the interface 28. The cooled regenerated catalyst stream contacts the preheated reactant stream from the feed line 8*.

The foregoing disclosure describes a process and apparatus that enables the regenerator 60 to be operated at the optimal temperature for catalyst regeneration while independently operating the reactor 10 with an optimal catalyst reactor residence time.

The paraffin feed in line 6 can be heated by about 300 to about 500° C., and the hot recycle catalyst stream can be cooled by about 50 to about 100° C.

The catalyst cooler 92* may also be used to generate steam, superheat steam or provide heat to another area of the process while cooling catalyst to be returned to the reactor 10* in the cooled catalyst pipe 120 to enable a higher catalyst circulation rate independent of catalyst regeneration conditions.

All the catalyst coolers 92, 92′,92″ and 92* may be shell and tube, nested tube, plate heat exchangers or any other type of heat exchanger.

### EXAMPLE

Catalyst was prepared by incipient wetness impregnation of an aqueous solution of gallium nitrate, potassium nitrate, and tetraamine platinum nitrate on a micro-spheroidal spray dried alumina containing 1% SiO₂. The catalyst support had BET surface area of 134 m²/g measured by nitrogen adsorption. Impregnation was followed by calcination in air for 4 hours at 750° C. Catalyst contained 0.0076% Pt, 1.56% Ga, 0.26% K, 0.5% Si (by weight) as measured by inductively charged plasma atomic emission spectroscopy (ICP-AES). Catalyst appearance was white. Carbon and nitrogen content were measured by CHN method D5291. Carbon content of the fresh catalyst was 0.07 wt %, close to the detection limit of 0.05 wt % (likely due to adsorbed carbonates). Nitrogen was not detectable (detection limit 0.05 wt %).

Long-term aging of catalyst was simulated by cycling the catalyst between reactor and regenerator conditions as follows:

Startup: 2 cm³ of catalyst was loaded in a quartz tube reactor. Catalyst was heated to 120° C. in nitrogen and held 30 minutes. Temperature was increased to 720° C. in nitrogen at 10° C./min and regeneration conditions were initiated.
Regeneration step: Temperature was increased to 720° C. in nitrogen at 10° C./min. Gas composition was changed from nitrogen to 5% O₂, 24.2% H₂O, balance Na (by volume) and was flowed for 2 minutes with gas flow rate of 15 standard cm³ per minute per cm³ of catalyst. Gas composition was changed back to nitrogen, temperature was held for 0.5 min, and cooling was initiated.
Reaction step: Sample was cooled to 620° C. in nitrogen at 13° C./min. Gas composition was changed from nitrogen to propane. Propane was flowed for 2 minutes with gas flow rate of 7.5 cm³ per minute per cm³ of catalyst. Gas composition was changed back to nitrogen, temperature was held for 0.5 min, and heating for regeneration step was initiated. 630 cycles of regeneration-reaction were completed, with an additional regeneration at the end of the program. Catalyst was cooled in nitrogen and unloaded for further testing.

We tested the aged platinum-gallium catalyst for activity at different regeneration temperatures in a propane dehydrogenation test apparatus. We simulated catalyst regeneration at various temperatures in an environment of 25 wt % water, 5 wt % oxygen and the balance nitrogen for 1 minute. 150 mg of the aged catalyst described above was loaded between quartz wool plugs in a quartz tube reactor with inner diameter 3.85 mm. Inert alpha alumina spheres were loaded below the catalyst bed to minimize thermal cracking. The reactor effluent composition was analyzed by transmission infrared spectroscopy which identified propane, propene, ethane, ethene, and methane products with data collection approximately every 7 sec. The effluent of the infrared analyzer was directed to a gas chromatograph which was used to occasionally analyze the product stream and check the accuracy of the infrared analyzer on the real product stream.

Catalyst was dried in nitrogen and held for 30 minutes at 120° C., then heated to the regeneration temperatures of 690, 705, 720 and 735° C. in nitrogen. The catalyst was then exposed to a mixture of dry gas consisting of 5 mol % O₂ with the balance nitrogen, where the dry gas flow of O₂ and nitrogen was 15 standard cm³/min, mixed with 25 mole % steam generated by vaporizing water which was fed from a pump. Exposure to this steam/O₂/nitrogen mixture was sustained for 1 minute, at which point it was discontinued and replaced with dry nitrogen.

After this pretreatment, the catalyst was cooled to 620° C. in dry nitrogen. The catalyst was then exposed to 2 mol % H₂O in nitrogen, generated by bubbling nitrogen through a saturator in a temperature-controlled bath. The wet pre-treatment of the catalyst was maintained for 60 minutes. The nitrogen/H₂O mixture was then stopped and replaced with 9 standard cm³/min of propane and 1.5 standard cm³/min of hydrogen feed. Feed flowed for 2 minutes, after which gas composition was switched to nitrogen. The temperature was increased to the regeneration temperatures of 690, 705, 720 or 735° C. for regeneration. During regeneration, the catalyst was then exposed to a mixture of dry gas consisting of 5 mol % O₂ with the balance nitrogen, where the dry gas flow of O₂ and nitrogen was 15 standard cm³/min, mixed with 25 mole % steam generated by vaporizing water which was fed from a pump. Exposure to this steam/O₂/nitrogen mixture was sustained for 1 minute, at which point it was discontinued and replaced with dry nitrogen. The catalyst was then cooled to 620° C. for the next reaction step. The O₂/propane cycles were repeated four times.

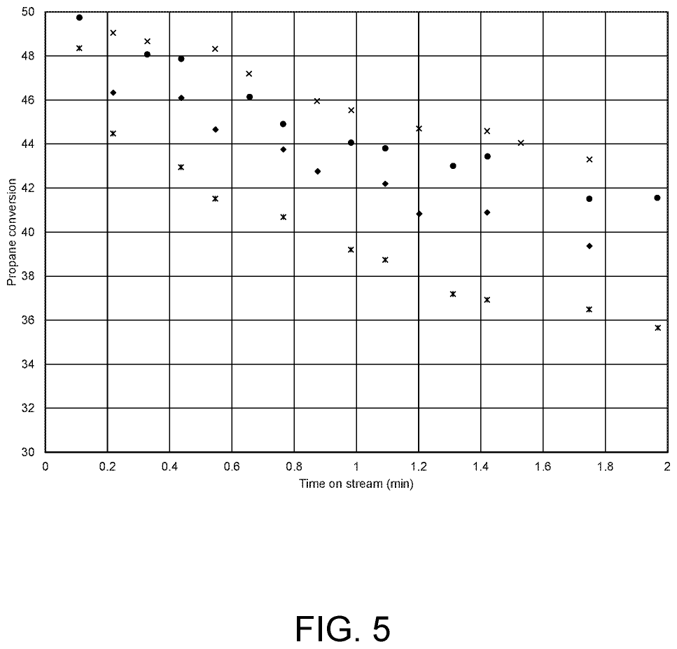

The propane conversion at or near 0.54 min on stream in the fourth cycle is shown in Table 1 for experiments with four different regeneration temperatures. Conversion vs. time on stream, representing reactor residence time, is shown in FIG. 5. The legend key for FIG. 5 is provided in the last column of Table 1. Higher regeneration temperature results in higher propane conversion in the subsequent reaction cycle. At shorter reactor residence times in the reactor, conversion which corresponds to activity is higher.

TABLE 1

| Regeneration temperature, ° C. | Propane conversion | Key for FIG. 5 |
|---|---|---|
| 690 | 41.52 | * |
| 705 | 44.66 | ♦ |
| 720 | 47.00^{a} | ● |
| 735 | 48.32 | x |

^{a}No datapoint at 0.54 min, so reported average of conversion at 0.44 and 0.66 min.

### Specific Embodiments

While the following is described in conjunction with specific embodiments, it will be understood that this description is intended to illustrate and not limit the scope of the preceding description and the appended claims.

A first embodiment of the disclosure is a process for contacting a reactant stream with regenerated catalyst comprising charging a reactant stream to a reactor; contacting the reactant stream with a cooled regenerated catalyst stream to produce a product gas stream and a spent catalyst; passing a spent catalyst stream to a regenerator; regenerating the spent catalyst stream by combustion in the regenerator to provide a hot regenerated catalyst stream and a flue gas stream; cooling a catalyst stream; and passing the regenerated catalyst stream to the reactor. An embodiment of the disclosure is one, any or all of prior embodiments in this paragraph up through the first embodiment in this paragraph further comprising cooling the hot regenerated catalyst stream by heat exchange. An embodiment of the disclosure is one, any or all of prior embodiments in this paragraph up through the first embodiment in this paragraph further comprising cooling the hot regenerated catalyst by heat exchange with air. An embodiment of the disclosure is one, any or all of prior embodiments in this paragraph up through the first embodiment in this paragraph further comprising returning heated air from the heat exchange to the regenerator. An embodiment of the disclosure is one, any or all of prior embodiments in this paragraph up through the first embodiment in this paragraph further comprising cooling the hot regenerated catalyst stream by heat exchange with the spent catalyst stream to provide the cooled regenerated catalyst stream and a heated spent catalyst stream. An embodiment of the disclosure is one, any or all of prior embodiments in this paragraph up through the first embodiment in this paragraph further comprising passing the cooled regenerated catalyst stream to the reactor and passing the heated spent catalyst stream to the regenerator. An embodiment of the disclosure is one, any or all of prior embodiments in this paragraph up through the first embodiment in this paragraph further comprising bypassing a portion of the hot regenerated catalyst stream around the heat exchange and/or bypassing a portion of the spent catalyst stream around the heat exchange. An embodiment of the disclosure is one, any or all of prior embodiments in this paragraph up through the first embodiment in this paragraph further comprising cooling the hot regenerated catalyst stream by mixing it with a cooled catalyst stream to provide the cooled regenerated catalyst stream. An embodiment of the disclosure is one, any or all of prior embodiments in this paragraph up through the first embodiment in this paragraph further comprising separating a recycle catalyst stream from a spent catalyst and cooling the recycle catalyst stream to provide the cooled catalyst stream. An embodiment of the disclosure is one, any or all of prior embodiments in this paragraph up through the first embodiment in this paragraph wherein contacting the reactant stream with a cooled regenerated catalyst stream produces an endothermic reaction. An embodiment of the disclosure is one, any or all of prior embodiments in this paragraph up through the first embodiment in this paragraph wherein the catalyst includes gallium.

A second embodiment of the disclosure is a process for contacting a reactant stream with regenerated catalyst comprising charging a reactant stream to a reactor; contacting the reactant stream with a cooled regenerated catalyst stream to produce a product gas stream and a spent catalyst; passing a first spent catalyst stream to a regenerator and optionally returning a second spent catalyst stream back to the contacting step; regenerating the spent catalyst stream by combustion in the regenerator to provide a regenerated catalyst stream and a flue gas stream; and cooling the regenerated catalyst stream or the second spent catalyst stream to provide the cooled regenerated catalyst stream. An embodiment of the disclosure is one, any or all of prior embodiments in this paragraph up through the second embodiment in this paragraph wherein the first spent catalyst stream and the regenerated catalyst stream are mixed to provide the cooled catalyst stream.

A third embodiment of the disclosure is an apparatus comprising a regenerator for regenerating catalyst; a regenerated catalyst pipe in downstream communication with the regenerator for transferring regenerated catalyst from a regenerator; a catalyst cooler in downstream communication with the regenerated catalyst pipe; a cooled catalyst pipe in downstream communication with the catalyst cooler; and a reactor in downstream communication with the cooled catalyst pipe. An embodiment of the disclosure is one, any or all of prior embodiments in this paragraph up through the third embodiment in this paragraph wherein the regenerated catalyst pipe has an inlet end connected to the regenerator and an outlet end connected to the catalyst cooler. An embodiment of the disclosure is one, any or all of prior embodiments in this paragraph up through the third embodiment in this paragraph wherein the cooled catalyst pipe has an inlet end connected to the catalyst cooler and an outlet end connected to the reactor. An embodiment of the disclosure is one, any or all of prior embodiments in this paragraph up through the third embodiment in this paragraph further comprising a first side of the catalyst cooler in communication with the regenerated catalyst pipe and the cooled catalyst pipe and a second side in communication with a spent catalyst pipe and a heated catalyst pipe. An embodiment of the disclosure is one, any or all of prior embodiments in this paragraph up through the third embodiment in this paragraph wherein the catalyst cooler is in downstream communication with the spent catalyst pipe and the regenerator is in downstream communication with the heated catalyst pipe. An embodiment of the disclosure is one, any or all of prior embodiments in this paragraph up through the third embodiment in this paragraph further comprising a regenerated catalyst bypass pipe having an inlet end connected to the regenerated catalyst pipe and an outlet end connected to the cooled catalyst pipe. An embodiment of the disclosure is one, any or all of prior embodiments in this paragraph up through the third embodiment in this paragraph further comprising a spent catalyst bypass pipe have an inlet end connected to the spent catalyst pipe and an outlet end connected to the heated catalyst pipe.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for contacting a reactant stream with regenerated catalyst comprising:
charging a reactant stream to a reactor;
contacting said reactant stream with a cooled regenerated catalyst stream to produce a product gas stream and a spent catalyst;
passing a spent catalyst stream to a regenerator;
regenerating said spent catalyst stream by combustion in said regenerator to provide a hot regenerated catalyst stream and a flue gas stream;
cooling a catalyst stream; and
passing said regenerated catalyst stream to the reactor.

2. The process of claim 1 further comprising cooling said hot regenerated catalyst stream by heat exchange.

3. The process of claim 2 further comprising cooling said hot regenerated catalyst by heat exchange with air.

4. The process of claim 3 further comprising returning heated air from said heat exchange to said regenerator.

5. The process of claim 2 further comprising cooling said hot regenerated catalyst stream by heat exchange with said spent catalyst stream to provide said cooled regenerated catalyst stream and a heated spent catalyst stream.

6. The process of claim 5 further comprising passing said cooled regenerated catalyst stream to said reactor and passing said heated spent catalyst stream to said regenerator.

7. The process of claim 5 further comprising bypassing a portion of said hot regenerated catalyst stream around said heat exchange and/or bypassing a portion of said spent catalyst stream around said heat exchange.

8. The process of claim 1 further comprising cooling said hot regenerated catalyst stream by mixing it with a cooled catalyst stream to provide said cooled regenerated catalyst stream.

9. The process of claim 8 further comprising separating a recycle catalyst stream from a spent catalyst and cooling said recycle catalyst stream to provide said cooled catalyst stream.

10. The process of claim 2 wherein contacting said reactant stream with a cooled regenerated catalyst stream produces an endothermic reaction.

11. The process of claim 2 wherein said catalyst includes gallium.

12. A process for contacting a reactant stream with regenerated catalyst comprising:
charging a reactant stream to a reactor;
contacting said reactant stream with a cooled regenerated catalyst stream to produce a product gas stream and a spent catalyst;
passing a first spent catalyst stream to a regenerator and optionally returning a second spent catalyst stream back to said contacting step;
regenerating said spent catalyst stream by combustion in said regenerator to provide a regenerated catalyst stream and a flue gas stream; and
cooling said regenerated catalyst stream or said second spent catalyst stream to provide said cooled regenerated catalyst stream.

13. The process of claim 12 wherein said first spent catalyst stream and said regenerated catalyst stream are mixed to provide said cooled catalyst stream.

14. A reactor apparatus comprising:
a regenerator for regenerating catalyst;
a regenerated catalyst pipe in downstream communication with said regenerator for transferring regenerated catalyst from a regenerator;
a catalyst cooler in downstream communication with said regenerated catalyst pipe;
a cooled catalyst pipe in downstream communication with said catalyst cooler; and
a reactor in downstream communication with said cooled catalyst pipe.

15. The reactor apparatus of claim 14 wherein said regenerated catalyst pipe has an inlet end connected to said regenerator and an outlet end connected to said catalyst cooler.

16. The reactor apparatus of claim 14 wherein said cooled catalyst pipe has an inlet end connected to said catalyst cooler and an outlet end connected to said reactor.

17. The reactor apparatus of claim 16 further comprising a first side of said catalyst cooler in communication with said regenerated catalyst pipe and said cooled catalyst pipe and a second side in communication with a spent catalyst pipe and a heated catalyst pipe.

18. The reactor apparatus of claim 17 wherein said catalyst cooler is in downstream communication with said spent catalyst pipe and said regenerator is in downstream communication with said heated catalyst pipe.

19. The reactor apparatus of claim 18 further comprising a regenerated catalyst bypass pipe having an inlet end connected to said regenerated catalyst pipe and an outlet end connected to said cooled catalyst pipe.

20. The reactor apparatus of claim 19 further comprising a spent catalyst bypass pipe have an inlet end connected to said spent catalyst pipe and an outlet end connected to said heated catalyst pipe.
